(19) United States
(12) Patent Application Publication
(10) Pub. No.: US 2018/0341336 A1
(43) Pub. Date: Nov. 29, 2018

(54) OPTICAL INDICATION FOR KEYBOARD INPUT SUGGESTION

(71) Applicant: Microsoft Technology Licensing, LLC, Redmond, WA (US)

(72) Inventor: Trevor H. NORRBOM, Murrieta, CA (US)

(73) Assignee: Microsoft Technology Licensing, LLC, Redmond, WA (US)

(21) Appl. No.: 15/605,883

(22) Filed: May 25, 2017

(51) Int. Cl. G06F 3/02; G02B 27/01; G06F 3/0489

(52) U.S. Cl. CPC G06F 3/0219; G06F 3/0227; G06F 3/04895; G02B 27/017

(57) ABSTRACT

A computing device is provided, including a keyboard including a plurality of keys. One or more keys may be equipped with a lighting mechanism configured to display an optical indication. The computing device may further include at least one secondary input device and a processor. The processor may detect a secondary input received from the at least one secondary input device, and may determine that the secondary input corresponds to an input function of an application program set to a tutorial mode of operation. The processor may determine that a pre-defined keyboard input of at least one key of the one or more keys also corresponds to the input function. The processor may convey an output to the keyboard including instructions for the at least one key to display the optical indication. The at least one key of the keyboard, upon receiving the output, may display the optical indication.

### BACKGROUND

In many application programs, keyboard shortcuts may be used to input commands. Frequently, commands initiated via keyboard shortcuts may alternately be initiated using other input devices. Initiating commands using keyboard shortcuts may often be faster than initiating them using other input devices. A user who knows how to initiate commands using keyboard shortcuts may therefore be able to use an application program more efficiently and have an improved user experience. However, the user may not know the keyboard shortcut that initiates a particular command, or may have forgotten the keyboard shortcut. This may result in a sub-optimal user experience for the user.

### SUMMARY

To address the above issue, a computing device is provided, comprising a keyboard including a plurality of keys. One or more keys of the plurality of keys may be equipped with a lighting mechanism configured to display an optical indication. The computing device may further comprise at least one secondary input device and a processor. The processor may be configured to detect a secondary input received from the at least one secondary input device. The processor may be further configured to determine that the secondary input corresponds to an input function of an application program set to a tutorial mode of operation. The processor may be further configured to determine that a pre-defined keyboard input of at least one key of the one or more keys also corresponds to the input function. The processor may be further configured to convey an output to the keyboard including instructions for the at least one key to display the optical indication. The at least one key of the keyboard, upon receiving the output, may display the optical indication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic representation of a computing device, according to one embodiment of the present disclosure.

FIG. 2 shows a schematic representation of an application program, according to the embodiment of FIG. 1.

FIG. 3A shows a schematic representation of an example computing device, according to the embodiment of FIG. 1.

FIGS. 3B and 3C show responses of the keyboard of the computing device of FIG. 3A to instructions for at least one key to display an optical indication.

FIG. 4 schematically depicts a cross section of a mechanically-depressible key equipped with a lighting mechanism.

FIG. 5 shows an example keyboard equipped with a lighting mechanism that includes an addressable pixel display for one or more keys.

FIG. 6 schematically illustrates an example head-mounted display device.

FIG. 7 shows a flowchart of a method for displaying an optical indication corresponding to a keyboard input in response to receiving a secondary input.

FIG. 8 shows further steps of the method of FIG. 7 that may be performed in some embodiments.

FIG. 9 schematically shows an embodiment of a computing system that can enact one or more of the methods and processes described above.

### DETAILED DESCRIPTION

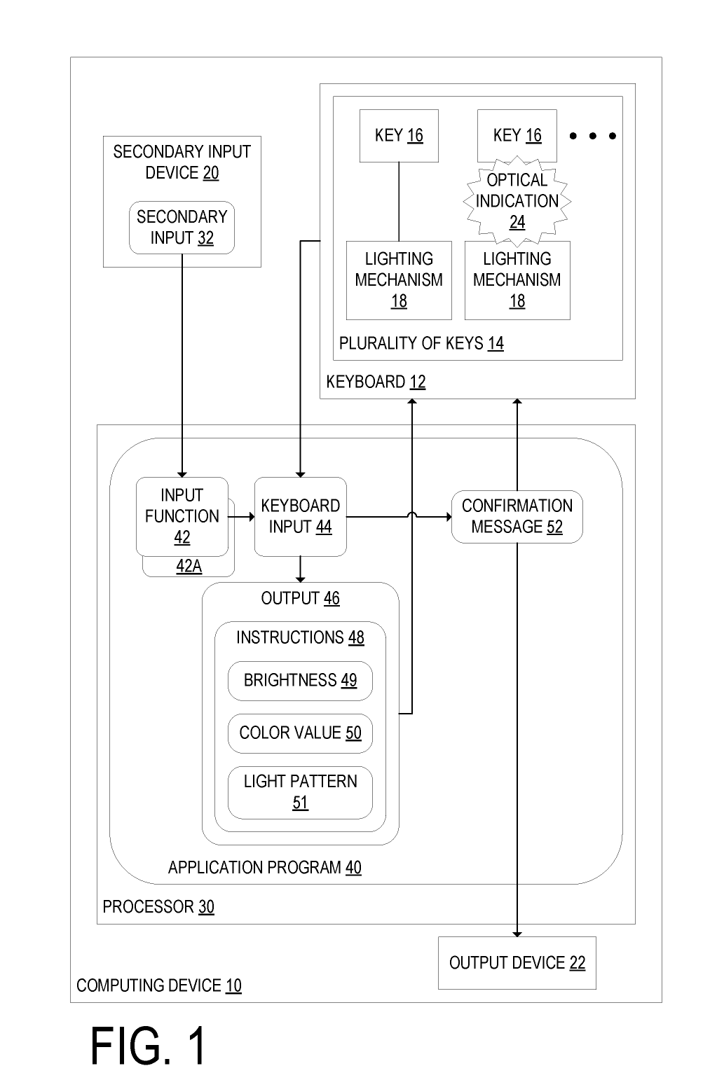

In view of the problem of users forgetting or not knowing keyboard shortcuts, as described above, the inventors has conceived of the following approach. FIG. 1 shows a schematic representation of a computing device 10 according to one embodiment of the present disclosure. The computing device 10 includes a keyboard 12 including a plurality of keys 14. One or more keys 16 of the plurality of keys 14 are equipped with a lighting mechanism 18 configured to display an optical indication 24. The optical indication provides a visual hint to the user that a keyboard shortcut is available for an input function, as explained below. In the embodiment of FIG. 1, each key 16 of the plurality of keys 14 is equipped with its own lighting mechanism 18. In other embodiments, a single lighting mechanism 18 may be used to control the illumination of each key 16 of the plurality of keys 14. The optical indication 24 may be a brightening and/or change in color of light emitted by the lighting mechanism 18. Alternatively, the optical indication 24 may be a dimming and/or change in color of light emitted by the lighting mechanism.

The computing device 10 further includes at least one secondary input device 20. The secondary input device 20 may be selected from the group consisting of a mouse, a trackpad, a touchscreen, a gaze detector and a microphone. The gaze detector may include one or more cameras configured to detect eyes of a user and compute an estimate of a location of the user's gaze upon a display of the device. Alternately, the secondary input device 20 may be some other input device, such as a pointing stick, joystick, trackball, etc.

The computing device 10 further includes a processor 30. The processor 30 is configured to detect a secondary input 32 received from the at least one secondary input device 20. For example, the secondary input 32 may be a mouse click, mouseover, or other mouse movement, a touch of a digit or stylus received by a touchscreen, a gaze of the user, a hover of a digit or stylus over a touchscreen, or a spoken command. The processor 30 is further configured to determine that the secondary input 32 corresponds to an input function 42 of an application program 40 set to a tutorial mode of operation. Non-limiting examples of input functions 42 include cut, copy, paste, undo, delete, and zoom in and out. The tutorial mode of operation is defined as a mode in which hints are given to the user in the form of optical indications via the lighting mechanism, to inform the user that a keyboard shortcut exists for the input function. The tutorial mode is typically implemented while the user is using various application programs executed the computing device as the user normally would use them. This is in contrast to the normal mode, described below, in which such the lighting mechanisms are not lighted to provide such hints. The processor 30 is further configured to determine that a pre-defined keyboard input 44 of at least one key 16 of the one or more keys 16 also corresponds to the input function 42. The keyboard input 44 may include input from at least two keys 16, which may be depressed concurrently. The processor 30 may, upon receiving secondary input 32 corresponding to an input function 42, check whether any keyboard input 44 corresponds to the same input function 42. The processor 30 may determine that a keyboard input 44 also corresponds to the input function 42 even if the keyboard input 44 is not received following the secondary input 32.

In response to determining that the keyboard input 44 corresponds to the input function 42, the processor 30 is configured to convey an output 46 to the keyboard 12. The output 46 includes instructions 48 for the at least one key 16 associated with the keyboard input 44 to display the optical indication 24. In some embodiments, the instructions 48 for the at least one key to display the optical indication 24 may include a color value 50. The at least one key 16 of the keyboard 12, upon receiving the output 46, is configured to display the optical indication 24. In embodiments in which the instructions 48 for the at least one key 16 to display the optical indication 24 include a color value 50, the lighting mechanism 18 may be configured to display the optical indication 24 with a color corresponding to the color value 50. Alternatively or in addition, the instructions 48 may include a brightness 49 (e.g., dim, medium, or bright) or light pattern 51 (e.g., flashing, strobing, etc.), and the optical indication 24 may be displayed with the instructed brightness 49 or light pattern 51. The output 46 may include instructions 48 for the color and/or brightness 49 of the optical indication 24 to vary over an interval of time in which the optical indication 24 is displayed. For example, starting from a state of no illumination, the output 46 may include instructions 48 for the at least one key 16 to increase in brightness up to a predetermined brightness value, and then decrease in brightness until it returns to the state of no illumination.

After the user observes the optical indication 24, the user may respond at that time or at a later time by inputting the keyboard input 44 for the input function using the shortcut key or key combination associated with the input function. When the processor 30 receives the keyboard input 44 corresponding to the input function 42, rather than the secondary input 32, in response to detecting the keyboard input 44, the processor 30 may be configured to convey a confirmation message 52 to an output device 22, to provide feedback to the user and reinforce in the user's mind that the shortcut was successfully entered. The output device 22 may be the keyboard 12, or may be a display, a speaker, or some other output device. The confirmation message 52 may include at least one of a sound, an image, and additional instructions for the at least one key 16 to display the optical indication 24. For example, in response to detecting that a user has initiated the input function 42 using the keyboard input 44 instead of the secondary input 32, the processor 30 may generate a confirmation message 52 including a sound designed to reward the user. As another example, instead of or in addition to a sound, the confirmation message 52 may include additional instructions for the at least one key 16 to display the optical indication 24. Alternately, the confirmation message 52 may include instructions for the at least one key 16 to display a second optical indication different from the optical indication 24. The additional instructions for the at least one key 16 to display a second optical indication may include a color, a brightness, and/or a light pattern, each of which may vary over the time interval in which the second optical indication is displayed. The color, brightness, and/or light pattern of the second optical indication 24 may differ from those of the optical indication 24. For example, the second optical indication may differ from the optical indication 24 in color and/or duration. In this way, confirmation message may be visually distinguishable from the original visual hint provided by the first optical indication 24.

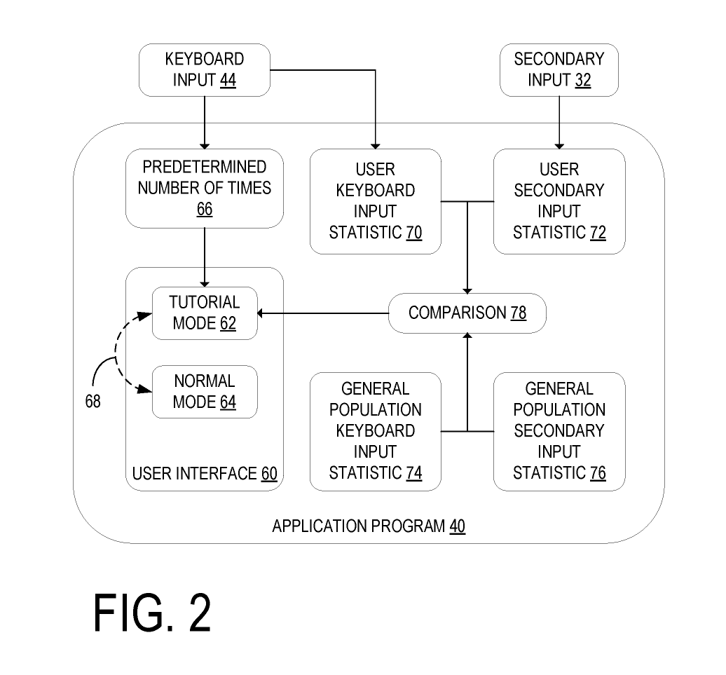

Referring now to FIG. 2, a schematic representation of the application program 40 is shown. The application program 40 may be set to the tutorial mode 62, or to a normal mode 64. The application program 40 may be set to the tutorial mode 62 by default when the user runs the application program 40 for the first time. When the application program 40 is set to the normal mode 64, the at least one key 16 does not display the optical indication 24 when a user inputs the secondary input 32 for input function 42 via secondary input device 20, since the display of the optical indication 24 is inhibited by the application program 40 in the normal mode.

Further, the processor 30 may be configured to determine that a predetermined condition is met that indicates that the user knows the keyboard input 44 well enough that providing the optical indication 24 would be unlikely to further improve the user experience. For example, in response to determining that the keyboard input 44 has been received a predetermined number of times 66, the processor 30 may be configured to set the application program 40 from the tutorial mode 62 to the normal mode 64 of operation. Alternatively, the predetermined condition may be, for example, another usage statistic of the user such as a ratio of the user's use of a keyboard shortcut vs. a secondary input device 20 to input a particular input function 42. When a sufficiently high ratio of use of the keyboard shortcut has been achieved for a particular input function by the user, the normal mode may be enacted for that input function. Further, if the user's usage of a particular keyboard input 44 for a keyboard shortcut falls below a minimum threshold usage, the application program 40 may be configured to return from the normal mode to the tutorial mode 62.

The application program 40 may have a tutorial mode 62 and a normal mode 64 for each of a plurality of keyboard inputs, wherein each keyboard input 44 of the plurality of keyboard inputs corresponds to an input function 42. The keyboard inputs may be set to the tutorial mode 62 and the normal mode 64 independently of each other. For each keyboard input 44, a user interface 60 displayed to the user may be configured to receive a normal mode setting 68 indicating that the normal mode 64 is to be applied. The user interface 60 may indicate, for each keyboard input 44, whether the application program 40 is set to the tutorial mode 62 or the normal mode 64 for that keyboard input 44. In the user interface 60, the user may also, for each input function 42, be provided with an option to toggle the application program 40 between the tutorial mode 62 and the normal mode 64.

In some embodiments, the processor 30 may be configured to determine a user keyboard input statistic 70 for the input function 42 initiated via the keyboard input 44 and a user secondary input statistic 72 for the input function 42 initiated via the secondary input 44. For example, the user keyboard input statistic 70 may be a first frequency with which the processor 30 receives the keyboard input 44, and the user secondary input statistic 72 may be a second frequency with which the processor 30 receives the secondary input 32. Alternatively, in embodiments in which the application program 40 includes a plurality of input functions which may be initiated using a keyboard input 44 or secondary input 32, the processor 30 may aggregate the frequencies with which it receives the keyboard input 44 and secondary input 32 for each input function 42 of the plurality of input functions into the user keyboard input statistic 70 and user secondary input statistic 72 respectively. The processor 30 may be further configured to respectively compare the user keyboard input statistic 70 and the user secondary input statistic 72 to a general population keyboard input statistic 74 and a general population secondary input statistic 76. For example, the general population keyboard input statistic 74 may be a first mean frequency with which users in a population of users initiate the input function 42 using the keyboard input 44, and the general population secondary input statistic 76 may be a second mean frequency with which users in the population of users initiate the input function 42 using the secondary input 32. Alternatively, the general population keyboard input statistic 74 and the general population secondary input statistic 76 may be aggregate frequencies with which users in the population of users initiate any input function 42 of a plurality of input functions using a keyboard input 44 and a secondary input 32 respectively, in embodiments in which the application program 40 includes a plurality of input functions that may be initiated using either a keyboard input 44 or a secondary input 32. Based on a result of the comparison 78, the processor 30 may set the application program 40 from the tutorial mode 62 to the normal mode 64. For example, the processor 30 may determine that the first frequency is within a predetermined threshold of similarity to the first mean frequency for a particular keyboard input 44, and, based on that comparison 78, set the application program 40 from the tutorial mode 62 to the normal mode 64. The comparison 78 may be made at the computing device 10, or may be made at a server with which the computing device 10 is configured to communicate over a network.

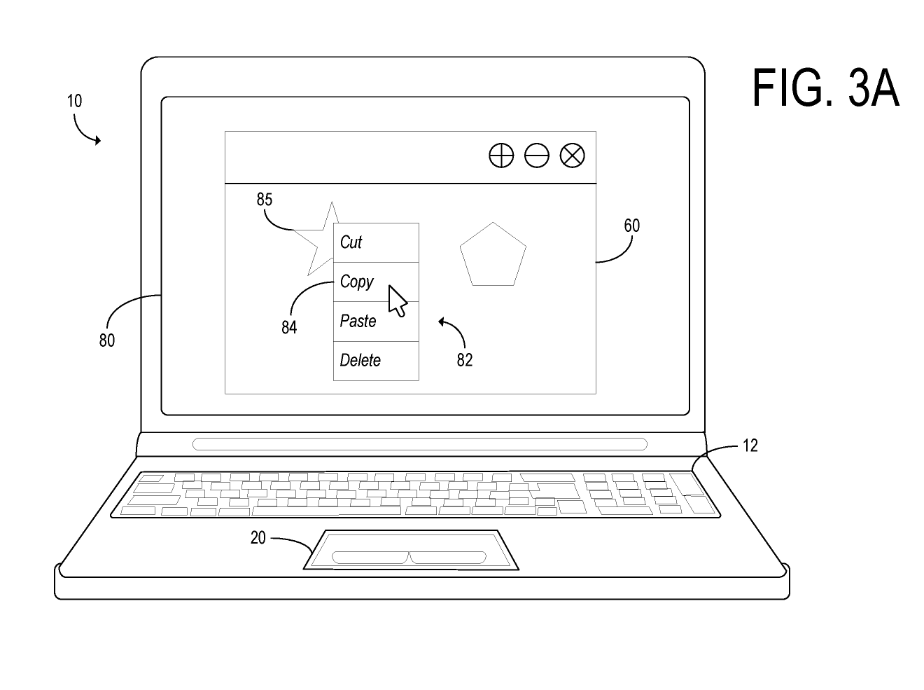

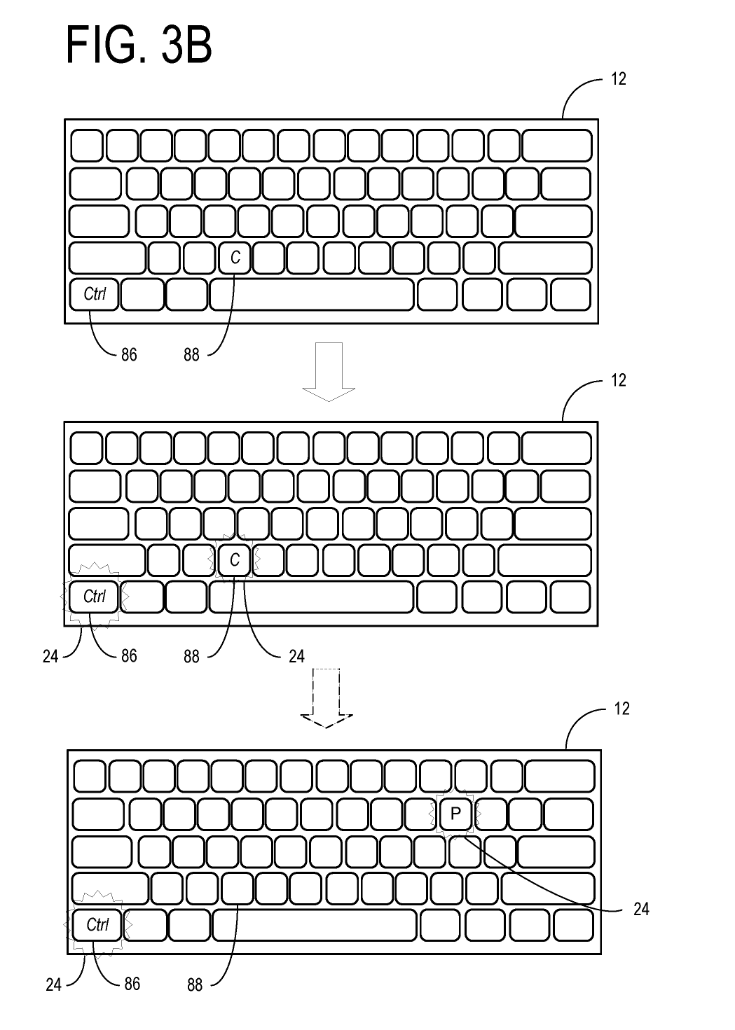

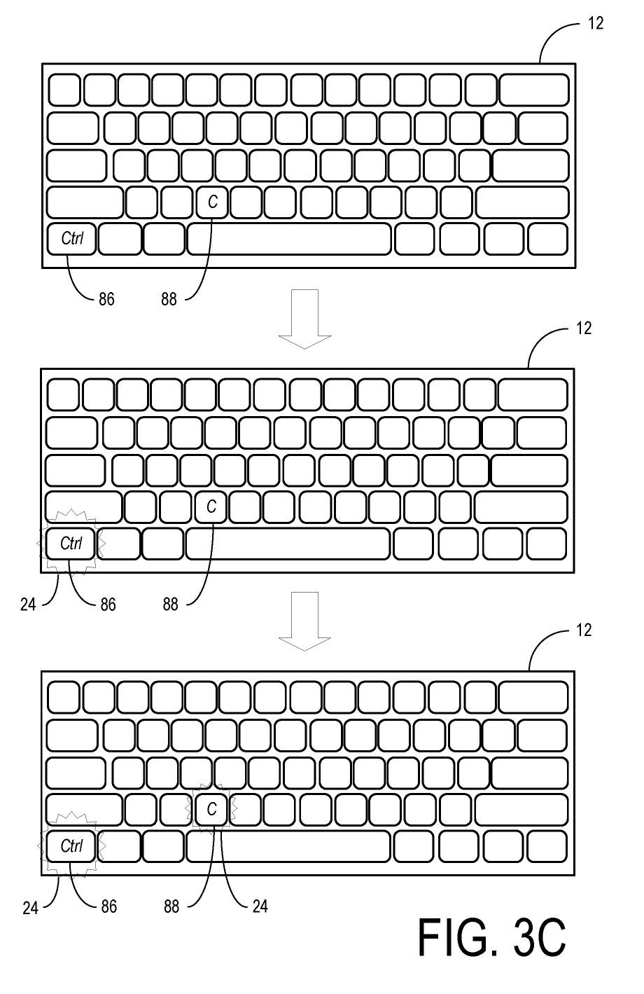

Referring now to FIG. 3A, a schematic representation of an example computing device 10 is shown. The computing device 10, as depicted in FIG. 3A, includes a keyboard 12, a display 80, and a secondary input device 20, wherein the secondary input device 20 is a trackpad. A user interface 60 associated with an application program 40 is displayed on the screen 80. The user interface 60 includes a menu 82, which includes at least one option 84 to initiate an input function 42 using a secondary input 32. As shown in FIG. 3A, the option 84 is an option to copy a data object 85. The input function 42 of copying the data object 85 may also be initiated using a keyboard input 44.

FIG. 3B shows a response of the keyboard 12 to instructions 48 for the at least one key to display an optical indication 24, according to the embodiment of FIG. 3A. The keyboard input 44 that initiates the input function 42 of copying the data object 85 is Ctrl+C. In response to the processor 30 receiving the secondary input 32 to copy the data object 85, the processor 30 is configured to convey to the keyboard 12 instructions 48 for the at least one key to display an optical indication 24. In response to receiving the instructions 48, the Ctrl key 86 and the C key 88 may display the optical indication 24.

Alternatively, the secondary input 32 may be an input that can be used to infer a user intention to input the input function 42, but that does not complete the act of inputting the input function 42. For example, a user may hover a digit or stylus or may position the cursor over (mouseover) or may gaze at the COPY menu option in the user interface of FIG. 3A, without selecting COPY, and this hover or mouseover or gaze input may be the secondary input 32 that is associated with the copy input function 42, and causes the corresponding optical indication showed in FIG. 3B to be displayed.

FIG. 3C shows an alternate response of the keyboard 12 to instructions 48 for the at least one key to display an optical indication 24, according to the embodiment of FIG. 3A. In the example of FIG. 3C, the output 46 includes instructions 48 for a first key (the Ctrl key 86) of the at least two keys to display the optical indication 24. The output 46 further includes instructions 48 for a second key (the C key 88) of the at least two keys to begin to display the optical indication 24 after a predetermined time interval while the first key continues to display the optical indication 24.

Once the optical indication 24 is displayed on the keyboard, if the user has not yet completed the input of the input function 42, the user is free to either provide input via the keys of the keyboard that are being illuminated, or may continue with input via the secondary input device.

In another example, after the user has selected CTRL+C on the keyboard, the processor 30 is configured to determine a second input function 42A, such as a paste function, that is associated with the first input function 42, in this example a copy function, and is configured to convey an output to the keyboard including instructions for the key or keys associated with the shortcut function to display the optical indication 24 via the lighting mechanism 16 on keys 16 associated with the secondary function 42A, such as CTRL and P illustrated at the bottom of FIG. 3B. In this manner, the user may be presented with an optical hint of a keyboard shortcut for a sequential function that the user may wish to perform after the previous input function is performed.

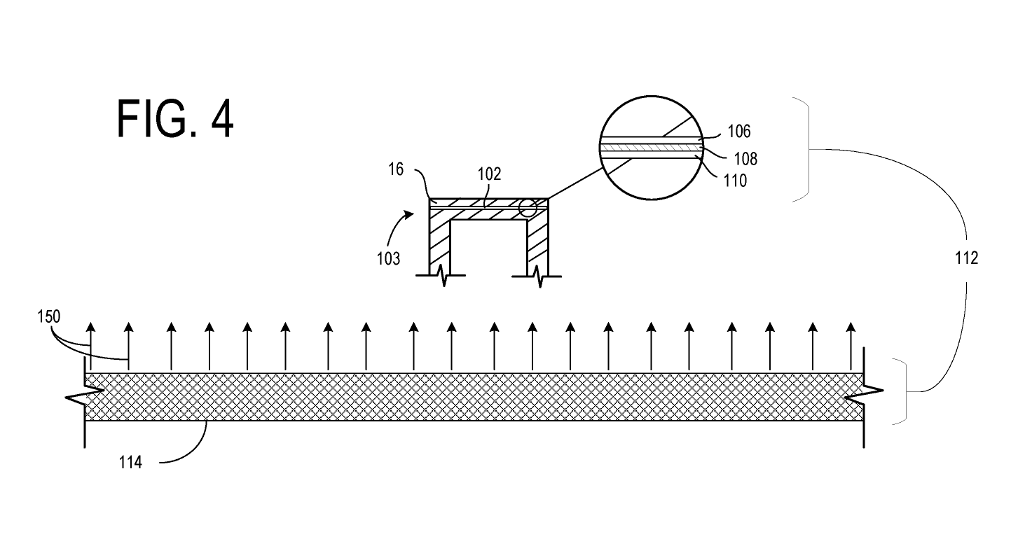

FIG. 4 schematically depicts a cross section of a mechanically-depressible key 16 equipped with a lighting mechanism 112 that includes a light source 114, a light pipe 110, and a light emitter 106. The light source 114 is located underneath the key, and provides image light 150 that is directed upward for viewing by a user through the key 16. The directional arrows associated with image light 150 are exemplary only, and it is contemplated that the image light can be diffuse and/or emanating in directions other than those indicated by the arrows. The light pipe 110 and light emitter 106, along with a light control film 108, are included in an optical element 102 of the mechanically-depressible key 16. The light pipe 110 may be a turning film, and the light emitter 106 may be a diffuser. Optical element 102 may be generally located within or near an upper portion 103 of key 16. It will be appreciated that key 16 provides an example implementation that may be used with some or all of the keys shown in the other figures of the present application. Relative dimensions in the figure are for the purposes of illustration and clarity only; actual dimensions may vary from those in the figure.

An upper portion of the key may include an optical element to enhance through-key viewing of image light. Optical element 102 may be generally located within or near upper portion 103 of key 16. The optical element 102 may be formed in a layered construction, including a light emitter 106, light control film 108 and light pipe 110. As shown, the diffuser is positioned above the light control film which is positioned above the light pipe 110. However, the number as well as the stacking order of the layers may be altered in other examples. These layers may be formed using any appropriate manufacturing method or technique, such as molded, adhesively bonded, ultrasonically welded, etc. Moreover, the layers (diffuser, light control film, and turning film) may be disposed in various locations near the upper portion 103 of the key 16.

A set of indicatable keys used in a set of frequently used keyboard inputs 44 may be equipped with lighting mechanisms 112. The processor 30 may be configured to determine which keys of the plurality of keys 14 are indicatable. The keyboard 12 may include read-only memory in which a list of indicatable keys is stored. Alternatively, each non-ghosting combination of keys may be addressable by the lighting mechanisms 112, for example, if each key 16 of the plurality of keys 14 is equipped with a separate lighting mechanism 112. This information may be read by the computing device 10 when the keyboard 12 is connected to the computing device, and used by an operating system and the application program 40 to determine which input functions should be hinted with optical indications of the one or more keys associated with their keyboard shortcuts. In this manner, when different keyboards having different lighting capabilities are connected, the application program 40 can still effectively provide keyboard shortcut hints.

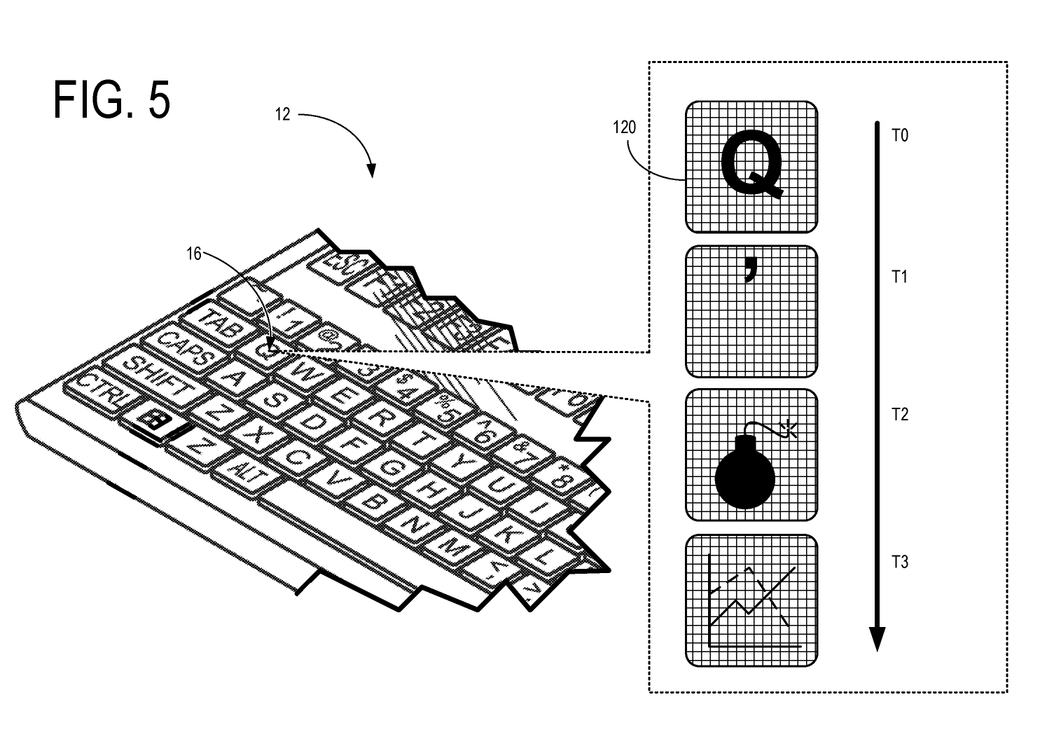

FIG. 5 provides further illustration of how the display capability of keyboard 12 may be employed in connection with an individual key 16. The lighting mechanism 18 of the key 16 may include an addressable pixel display 120 on each key for each key 16 of the one or more keys. As shown respectively at times T0, T1, T2, etc., the optical indication 24 associated with key 16 may be changed, for example to reflect the input function 42 produced by depressing the key 16. In the embodiment of FIG. 5, the instructions 48 for the at least one key 16 to display the optical indication 24 may include a color, brightness 49, and/or light pattern 51 for each pixel of the addressable pixel display 120 of the at least one key 16.

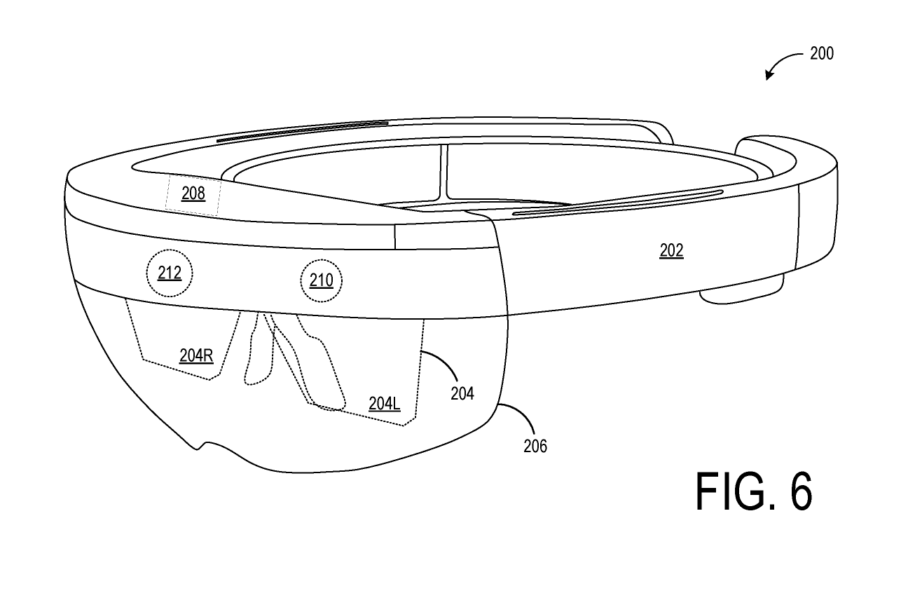

According to another embodiment of the present disclosure, a computing device 10 comprising a keyboard 12 including a plurality of keys 14, at least one secondary input device 20, and a head-mounted display device with an at least partially see-through display is provided. FIG. 6 schematically illustrates an example head-mounted display device 200. The head-mounted display device 200 includes a frame 202 in the form of a band wearable around a head of user that supports see-through display componentry positioned nearby the user's eyes. The head-mounted display device 200 may use augmented reality technologies to enable simultaneous viewing of virtual display imagery and a real-world background. As such, the head-mounted display device 200 may generate virtual images via see-through display 204, which includes separate right and left eye displays 204R and 204L, and which may be wholly or partially transparent. The see-through display 204 may take any suitable form, such as a waveguide or prism configured to receive a generated image and direct the image towards a wearer's eye. The see-through display 204 may include a backlight and a microdisplay, such as liquid-crystal display (LCD) or liquid crystal on silicon (LCOS) display, in combination with one or more light-emitting diodes (LEDs), laser diodes, and/or other light sources. In other examples, the see-through display 204 may utilize quantum-dot display technologies, active-matrix organic LED (OLED) technology, and/or any other suitable display technologies. It will be understood that while shown in FIG. 6 as a flat display surface with left and right eye displays, the see-through display 204 may be a single display, may be curved, or may take any other suitable form.

The head-mounted display device 200 further includes an additional see-through optical component 206, shown in FIG. 6 in the form of a see-through veil positioned between the see-through display 204 and the real-world environment as viewed by a wearer. A controller 208 is operatively coupled to the see-through optical component 206 and to other display componentry. The controller 208 includes one or more logic devices and one or more computer memory devices storing instructions executable by the logic device(s) to enact functionalities of the head-mounted display device 200. The head-mounted display device 200 may further include various other components, for example a two-dimensional image camera 210 (e.g. a visible light camera and/or infrared camera) and a depth imaging device 212, as well as other components that are not shown, including but not limited to speakers, microphones, accelerometers, gyroscopes, magnetometers, temperature sensors, touch sensors, biometric sensors, other image sensors, eye-gaze detection systems, energy-storage components (e.g. battery), a communication facility, a GPS receiver, etc.

In the embodiment of FIG. 6, the computing device 10 further includes a processor 30 configured to detect a secondary input 32 received from the at least one secondary input device 20. The processor 30 is further configured to determine that the secondary input 32 corresponds to an input function 42 of an application program 40 set to a tutorial mode of operation. The processor 30 is further configured to determine that a keyboard input 44 received from at least one key 16 of the plurality of keys 14 also corresponds to the input function 42. The processor 30 may make this determination if the application program 40 includes a keyboard input 44 that, when input into the keyboard 12, initiates the input function 42, even if the processor 30 does not detect the keyboard input 44 after it detects the secondary input 32. In response to this determination, the processor 30 is further configured to convey an output 46 to the head-mounted display device 200 including instructions for the head-mounted display device 200 to display a virtual image overlapping the at least one key 16. The virtual image may indicate that the at least one key 16 may be used to initiate the input function 42. For example, the virtual image may appear to be a flashing light superimposed over the at least one key 16.

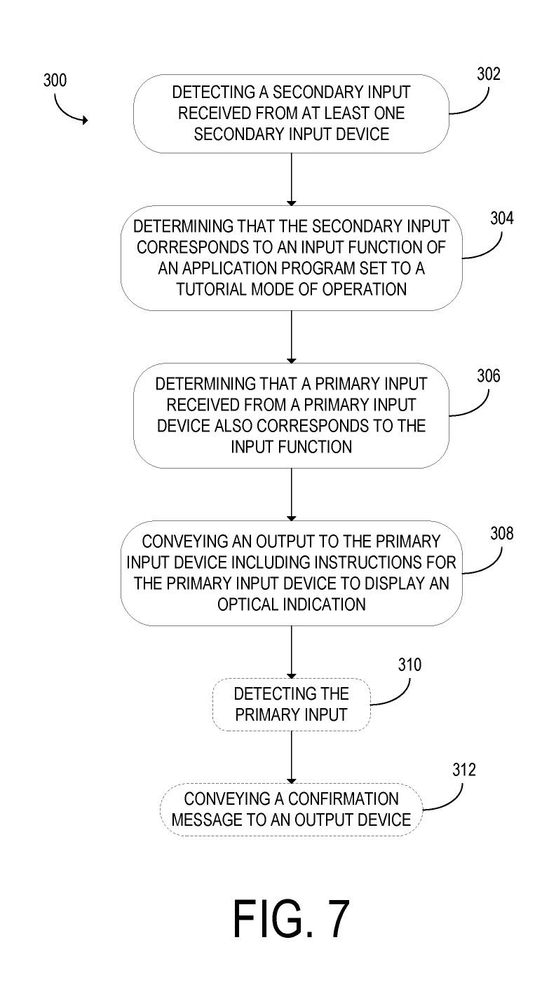

FIG. 7 shows a flowchart of a method 300 for use with a computing device. The method 300 comprises steps performed at a processor. At step 302, the method includes detecting a secondary input received from at least one secondary input device. At step 304, the method further includes determining that the secondary input corresponds to an input function of an application program set to a tutorial mode of operation. At step 306, the method further includes determining that a primary input that may be received from a primary input device also corresponds to the input function. The primary input device may be a keyboard, and the primary input may include input from at least one key of the keyboard. At step 308, the method includes conveying an output to the primary input device including instructions for the primary input device to display an optical indication. When the primary input device is a keyboard, the instructions for the primary input device to display the optical indication may be instructions for the at least one key of the keyboard to display the optical indication. The instructions for the primary input device to display the optical indication may include a color value with which the optical indication is to be displayed.

In embodiments in which the primary input device is a keyboard, the keyboard input may include input from at least two keys. In such embodiments, the output may include instructions for a first key of the at least two keys to display the optical indication. The output may further include instructions for a second key of the at least two keys to begin to display the optical indication after a predetermined time interval while the first key continues to display the optical indication.

FIG. 7 also shows steps that may optionally be performed in some embodiments. At step 310, the method may include detecting that the primary input has been received. At step 312, the method may include, in response to detecting the primary input, conveying a confirmation message to an output device. The output device may be the primary input device, or may be some other output device. The confirmation message may include at least one of a sound, an image, and additional instructions for the primary input device to display the optical indication.

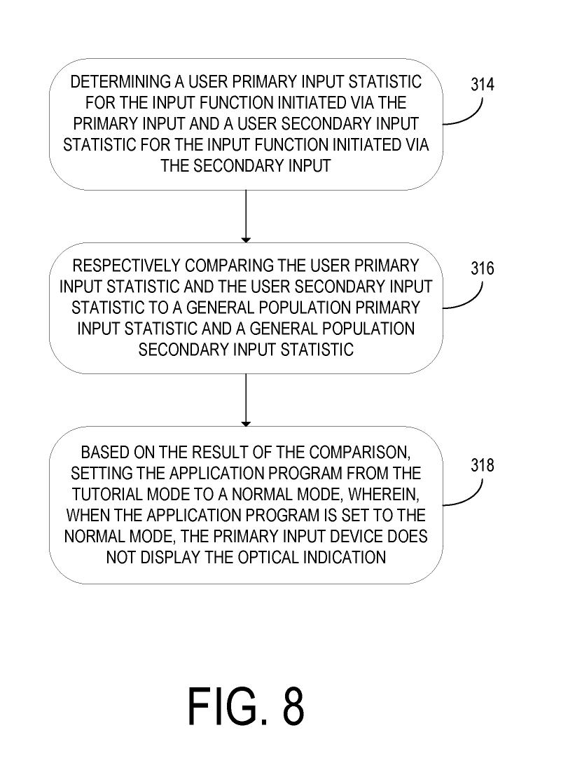

FIG. 8 shows further steps of the method 300 of FIG. 7 that may be performed at the processor of the computing device. At step 314, the method may include determining a user primary input statistic for the input function initiated via the primary input and a user secondary input statistic for the input function initiated via the secondary input. The user primary input statistic and the user secondary input statistic may be frequencies with which a user enters the primary input and secondary input respectively to initiate the input function when using the application program. At step 316, the method may include respectively comparing the user primary input statistic and the user secondary input statistic to a general population primary input statistic and a general population secondary input statistic. The general population primary input statistic and general population secondary input statistic may be mean frequencies with which users in a population of users enter the primary input and the secondary input respectively to initiate the input function when using the application program. At step 318, the method may include, based on a result of the comparison, setting the application program from the tutorial mode to a normal mode. When the application program is set to the normal mode, the primary input device may not display the optical indication.

In some embodiments, the methods and processes described herein may be tied to a computing system of one or more computing devices. In particular, such methods and processes may be implemented as a computer-application program or service, an application-programming interface (API), a library, and/or other computer-program product.

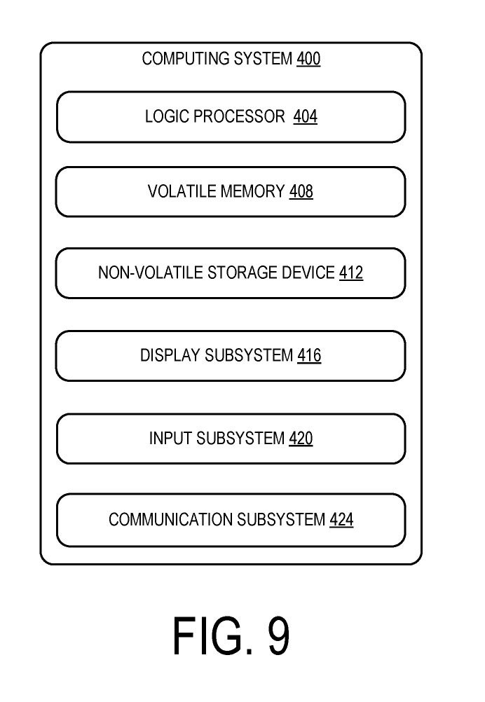

FIG. 9 schematically shows a non-limiting embodiment of a computing system 400 that can enact one or more of the methods and processes described above. Computing system 400 is shown in simplified form. Computing system 400 may take the form of one or more computing devices as shown in FIG. 1, or one or more devices cooperating with a computing device (e.g., personal computers, server computers, tablet computers, home-entertainment computers, network computing devices, gaming devices, mobile computing devices, mobile communication devices (e.g., smart phone), and/or other computing devices). Computing system 400 may alternately take the form of a head-mounted display device, as shown in FIG. 6, or one or more devices cooperating with a head-mounted display device.

Computing system 400 includes a logic processor 404, volatile memory 408, and a non-volatile storage device 412. Computing system 400 may optionally include a display subsystem 416, input subsystem 420, communication subsystem 424, and/or other components not shown in FIG. 9.

Logic processor 404 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 404 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Volatile memory 408 may include physical devices that include random access memory. Volatile memory 408 is typically utilized by logic processor 404 to temporarily store information during processing of software instructions. It will be appreciated that volatile memory 408 typically does not continue to store instructions when power is cut to the volatile memory 408.

Non-volatile storage device 412 includes one or more physical devices configured to hold instructions executable by the logic processors to implement the methods and processes described herein. When such methods and processes are implemented, the state of non-volatile storage device 412 may be transformed—e.g., to hold different data.

Non-volatile storage device 412 may include physical devices that are removable and/or built-in. Non-volatile storage device 412 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 412 may include nonvolatile, dynamic, static, read/write, read-only, sequential-access, location-addressable, file-addressable, and/or content-addressable devices. It will be appreciated that non-volatile storage device 412 is configured to hold instructions even when power is cut to the non-volatile storage device 412.

Aspects of logic processor 404, volatile memory 408, and non-volatile storage device 412 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 400 implemented to perform a particular function. In some cases, a program may be instantiated via logic processor 404 executing instructions held by non-volatile storage device 412, using portions of volatile memory 408. It will be understood that different programs may be instantiated from the same application, service, code block, object, library, routine, API, function, etc. Likewise, the same program may be instantiated by different applications, services, code blocks, objects, routines, APIs, functions, etc. The term “program” encompasses individual or groups of executable files, data files, libraries, drivers, scripts, database records, etc.

When included, display subsystem 416 may be used to present a visual representation of data held by non-volatile storage device 412. As the herein described methods and processes change the data held by the non-volatile storage device, and thus transform the state of the non-volatile storage device, the state of display subsystem 416 may likewise be transformed to visually represent changes in the underlying data. Display subsystem 416 may include one or more display devices utilizing virtually any type of technology. Such display devices may be combined with logic processor 404, volatile memory 408, and/or non-volatile storage device 412 in a shared enclosure, or such display devices may be peripheral display devices.

When included, input subsystem 420 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection, gaze detection, and/or intent recognition; as well as electric-field sensing componentry for assessing brain activity; and/or any other suitable sensor.

When included, communication subsystem 424 may be configured to communicatively couple computing system 400 with one or more other computing devices. Communication subsystem 424 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

According to one aspect of the present disclosure, a computing device is provided, comprising a keyboard including a plurality of keys. One or more keys of the plurality of keys may be equipped with a lighting mechanism configured to display an optical indication. The computing device may further comprise at least one secondary input device. The computing device may further comprise a processor configured to detect a secondary input received from the at least one secondary input device. The processor may be further configured to determine that the secondary input corresponds to an input function of an application program. The processor may be further configured to determine that a pre-defined keyboard input of at least one key of the one or more keys also corresponds to the input function. The processor may be further configured to convey an output to the keyboard including instructions for the at least one key to display the optical indication, wherein the at least one key of the keyboard, upon receiving the output, may display the optical indication.

According to this aspect, the keyboard input may include input from at least two keys. According to this aspect, the output may include instructions for a first key of the at least two keys to display the optical indication, and, after a predetermined time interval, for a second key of the at least two keys to begin to display the optical indication while the first key continues to display the optical indication.

According to this aspect, the secondary input device may be selected from the group consisting of a mouse, a trackpad, a touchscreen, a gaze detector, and a microphone.

According to this aspect, it may be determined that the secondary input corresponds to the input function of the application program when the application program is set to a tutorial mode of operation. In response to determining that the keyboard input has been received a predetermined number of times, the processor may be configured to set the application program from the tutorial mode to a normal mode of operation, wherein, when the application program is set to the normal mode, the at least one key does not display the optical indication. According to this aspect, the input function may be a first input function and the optical indication may a first optical indication. The processor may be further configured to determine a second input function that is associated with the first input function. The processor may be further configured to convey an output to the keyboard including instructions for the one or more keys to display a second optical indication.

According to this aspect, the processor may be configured to determine a user keyboard input statistic for the input function initiated via the keyboard input and a user secondary input statistic for the input function initiated via the secondary input. According to this aspect, it may be determined that the secondary input corresponds to the input function of the application program when the application program is set to a tutorial mode of operation. The processor may be configured to respectively compare the user keyboard input statistic and the user secondary input statistic to a general population keyboard input statistic and a general population secondary input statistic, and based on a result of the comparison, set the application program from the tutorial mode to a normal mode. When the application program is set to the normal mode, the at least one key may not display the optical indication.

According to this aspect, the instructions for the at least one key to display the optical indication may include a color value, and the lighting mechanism may be configured to display the optical indication with a color corresponding to the color value.

According to this aspect, in response to detecting the keyboard input, the processor may be configured to convey a confirmation message to an output device, the confirmation message including at least one of a sound, an image, and additional instructions for the at least one key to display the optical indication.

According to this aspect, the lighting mechanism may include a light source, a light pipe, and a light emitter for each key of the one or more keys.

According to this aspect, the lighting mechanism may include an addressable pixel display on each key for each key of the one or more keys.

According to another aspect of the present disclosure, a method for use with a computing device is provided, the method comprising, at a processor, detecting a secondary input received from at least one secondary input device. The method may further comprise determining that the secondary input corresponds to an input function of an application program. The method may further comprise determining that a primary input received from a primary input device also corresponds to the input function. The method may further comprise conveying an output to the primary input device including instructions for the primary input device to display an optical indication.

According to this aspect, the primary input device may be a keyboard, and the primary input may include input from at least one key of the keyboard. According to this aspect, the keyboard input may include input from at least two keys. According to this aspect, the output may include instructions for a first key of the at least two keys to display the optical indication, and, after a predetermined time interval, for a second key of the at least two keys to begin to display the optical indication while the first key continues to display the optical indication.

According to this aspect, it may be determined that the secondary input corresponds to the input function of the application program when the application program is set to a tutorial mode of operation. The method may further comprise determining a user primary input statistic for the input function initiated via the primary input and a user secondary input statistic for the input function initiated via the secondary input. The method may further comprise respectively comparing the user primary input statistic and the user secondary input statistic to a general population primary input statistic and a general population secondary input statistic. The method may further comprise, based on a result of the comparison, setting the application program from the tutorial mode to a normal mode. When the application program is set to the normal mode, the at primary input device may not display the optical indication.

According to this aspect, the instructions for the primary input device to display the optical indication may include a color value.

According to this aspect, the method may further comprise, in response to detecting the primary input, conveying a confirmation message to an output device, the confirmation message including at least one of a sound, an image, and additional instructions for the primary input device to display the optical indication.

According to another aspect of the present disclosure, a computing device is provided, comprising a keyboard including a plurality of keys. The computing device may further comprise at least one secondary input device. The computing device may further comprise a head-mounted display device having an at least partially see-through display. The computing device may further comprise a processor configured to detect a secondary input received from the at least one secondary input device. The processor may be further configured to determine that the secondary input corresponds to an input function of an application program. The processor may be further configured to determine that a pre-defined keyboard input of at least one key of the plurality of keys also corresponds to the input function. The processor may be further configured to convey an output to the head-mounted display device including instructions for the head-mounted display device to display on the at least partially see-through display a virtual image overlapping the at least one key.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a keyboard including a plurality of keys, wherein one or more keys of the plurality of keys are equipped with a lighting mechanism configured to display an optical indication;
at least one secondary input device; and
a processor configured to:
detect a secondary input received from the at least one secondary input device;
determine that the secondary input corresponds to an input function of an application program when the application program is set to a tutorial mode of operation;
determine that a pre-defined keyboard input of at least one key of the one or more keys also corresponds to the input function;
convey an output to the keyboard including instructions for the at least one key to display the optical indication;
determine that the pre-defined keyboard input has been received a predetermined number of times; and
set the application program from the tutorial mode to a normal mode of operation in response to determining that the pre-defined keyboard input has been received the predetermined number of times;
wherein the at least one key of the keyboard, upon receiving the output, displays the optical indication when the application program is set to the tutorial mode; and
wherein the at least one key does not display the optical indication when the application program is set to the normal mode.

2. The computing device of claim 1, wherein the pre-defined keyboard input includes input from at least two keys.

3. The computing device of claim 2, wherein the output includes instructions for a first key of the at least two keys to display the optical indication, and, after a predetermined time interval, for a second key of the at least two keys to begin to display the optical indication while the first key continues to display the optical indication.

4. The computing device of claim 1, wherein the secondary input device is selected from the group consisting of a mouse, a trackpad, a touchscreen, a gaze detector, and a microphone.

5. (canceled)

6. The computing device of claim 1, wherein the input function is a first input function and the optical indication is a first optical indication, and the processor is further configured to:
determine a second input function that is associated with the first input function; and
convey an output to the keyboard including instructions for the one or more keys to display a second optical indication.

7. The computing device of claim 1, wherein the processor is configured to determine a user keyboard input statistic for the input function initiated via the pre-defined keyboard input and a user secondary input statistic for the input function initiated via the secondary input.

8. The computing device of claim 7,
wherein it is determined that the secondary input corresponds to the input function of the application program when the application program is set to the tutorial mode of operation; and
wherein the processor is configured to respectively compare the user keyboard input statistic and the user secondary input statistic to a general population keyboard input statistic and a general population secondary input statistic, and based on a result of the comparison, set the application program from the tutorial mode to the normal mode in which the at least one key does not display the optical indication.

9. The computing device of claim 1, wherein the instructions for the at least one key to display the optical indication include a color value, and wherein the lighting mechanism is configured to display the optical indication with a color corresponding to the color value.

10. The computing device of claim 1, wherein, in response to detecting the pre-defined keyboard input, the processor is configured to convey a confirmation message to an output device, the confirmation message including at least one of a sound, an image, and additional instructions for the at least one key to display the optical indication.

11. The computing device of claim 1, wherein the lighting mechanism includes a light source, a light pipe, and a light emitter for each key of the one or more keys.

12. The computing device of claim 1, wherein the lighting mechanism includes an addressable pixel display on each key for each key of the one or more keys.

13. A method for use with a computing device, the method comprising, at a processor:
detecting a secondary input received from at least one secondary input device;
determining that the secondary input corresponds to an input function of an application program when the application program is set to a tutorial mode of operation;
determining that a primary input received from a primary input device also corresponds to the input function;
conveying an output to the primary input device including instructions for the primary input device to display an optical indication when the application program is set to the tutorial mode;
determining that the primary input has been received a predetermined number of times; and
setting the application program from the tutorial mode to a normal mode of operation in response to determining that the primary input has been received the predetermined number of times, wherein the optical indication is not displayed when the application program is set to the normal mode.

14. The method of claim 13, wherein the primary input device is a keyboard, and wherein the primary input includes input from at least one key of the keyboard.

15. The method of claim 14, wherein the primary input includes input from at least two keys.

16. The method of claim 15, wherein the output includes instructions for a first key of the at least two keys to display the optical indication, and, after a predetermined time interval, for a second key of the at least two keys to begin to display the optical indication while the first key continues to display the optical indication.

17. The method of claim 13, wherein it is determined that the secondary input corresponds to the input function of the application program when the application program is set to the tutorial mode of operation, the method further comprising:
determining a user primary input statistic for the input function initiated via the primary input and a user secondary input statistic for the input function initiated via the secondary input;
respectively comparing the user primary input statistic and the user secondary input statistic to a general population primary input statistic and a general population secondary input statistic; and
based on a result of the comparison, setting the application program from the tutorial mode to the normal mode in which the primary input device does not display the optical indication.

18. The method of claim 13, wherein the instructions for the primary input device to display the optical indication include a color value.

19. The method of claim 13, further comprising, in response to detecting the primary input, conveying a confirmation message to an output device, the confirmation message including at least one of a sound, an image, and additional instructions for the primary input device to display the optical indication.

20. A computing device, comprising:
a keyboard including a plurality of keys;
at least one secondary input device;
a head-mounted display device having an at least partially see-through display; and
a processor configured to:
detect a secondary input received from the at least one secondary input device;
determine that the secondary input corresponds to an input function of an application program when the application program is set to a tutorial mode of operation;
determine that a pre-defined keyboard input of at least one key of the plurality of keys also corresponds to the input function;
convey an output to the head-mounted display device including instructions for the head-mounted display device to display on the at least partially see-through display a virtual image overlapping the at least one key when the application program is set to the tutorial mode;
determine that the pre-defined keyboard input has been received a predetermined number of times; and
set the application program from the tutorial mode to a normal mode of operation in response to determining that the pre-defined keyboard input has been received the predetermined number of times, wherein the optical indication is not displayed when the application program is set to the normal mode.

21. A method for use with a computing device, the method comprising, at a processor:
detecting a secondary input received from at least one secondary input device;
determining that the secondary input corresponds to an input function of an application program when the application program is set to a tutorial mode of operation;
determining that a primary input received from a primary input device also corresponds to the input function;
conveying an output to the primary input device including instructions for the primary input device to display an optical indication when the application program is set to the tutorial mode;
determining a user primary input statistic for the input function initiated via the primary input and a user secondary input statistic for the input function initiated via the secondary input;
respectively comparing the user primary input statistic and the user secondary input statistic to a general population primary input statistic and a general population secondary input statistic; and
based on a result of the comparison, setting the application program from the tutorial mode to a normal mode of operation, wherein, when the application program is set to the normal mode, the primary input device does not display the optical indication.
